(19) United States
(12) Patent Application Publication
(10) Pub. No.: US 2007/0075581 A1
(43) Pub. Date: Apr. 5, 2007

(54) Wheel hub lube director

(76) Inventor: Steven G. Slesinski, Kalamazoo, MI (US)

Correspondence Address: MARSHALL & MELHORN, FOUR SEAGATE, EIGHT FLOOR, TOLEDO, OH, 43604, US

(21) Appl. No.: 11/242,735

(22) Filed: Oct. 4, 2005

(51) Int. Cl. B60B 37/00

(52) U.S. Cl. 301/124.1

(57) ABSTRACT

A lubrication deflector for a vehicle wheel hub assembly is disclosed. The wheel hub assembly has an inner cavity which has a recessed region. The lubrication deflector is placed within the recessed cavity within the wheel hub to substantially close the recessed region.

### FIELD OF THE INVENTION

The present invention relates to a wheel hub for vehicles. More particularly, the present invention relates to a lube director for the wheel hub of heavy vehicles.

### BACKGROUND OF THE INVENTION

Greasing a wheel hub assembly is well known in the art. It is necessary to provide sufficient grease or oil to sufficiently lubricate the wheel bearings. However, the grease also adds to the weight of the assembly, and using more grease than is necessary for proper lubrication adds to the cost of maintenance of the wheel end. Current standards call for filling the hub cavity with grease to at least 50% of the cavity volume.

It is shown in U.S. Pat. No. 5,591,020 to provide a shaped lubrication chamber. The chamber has a tapered design which directs lubricant to lubricant channels adjacent the bearings.

U.S. Pat. No. 6,135,241 teaches a lubricant deflector integrally formed with an axle housing cover plate. The deflector is formed in a top portion of the cover plate adjacent the ring gear. Oil is deflected by the deflector outwardly toward the axle shaft and oil galleries proximate the bearing caps.

The present invention provides a simple construction for minimizing the usage of grease while directing oil flow to the bearings to increase their life.

### SUMMARY OF THE INVENTION

The present invention is a wheel hub lubrication system. The system comprises a body portion of the wheel hub which has an internal cavity and an annular lubricant depression within the internal cavity. A lubricant directing structure is secured within the annular lubricant depression to substantially close said annular depression.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a cross-section view of a hub in accordance with one embodiment of the present invention.

FIG. 2 is an alternative embodiment of a lubricant directing structure as shown in FIG. 1.

FIG. 3 is another alternative embodiment of the lubricant directing structure.

FIG. 4 is another alternative embodiment of the lubricant directing structure.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

The Figures show the inventive lube director used in various known wheel hubs. The Exact makeup of the wheel hub is not crucial to the present invention.

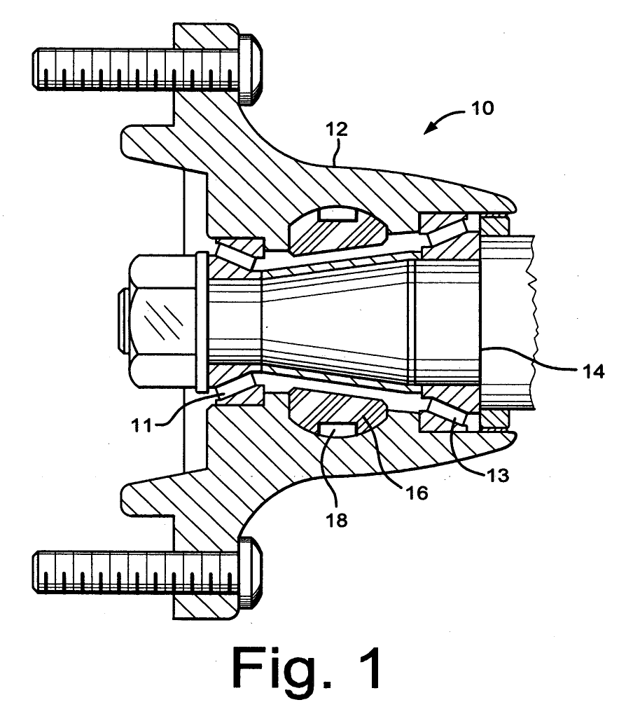

Referring now to FIG. 1, a cross-section of a wheel hub assembly 10 is shown. The hub assembly 10 is intended for use with a single wheel unit such as is commonly found on the front wheels of trucks. A main hub body or housing 12 is situated in the wheel (not shown) about the end of an axle 14. The axle 14 is supported in the hub region by roller bearings 11 and 13. Around the axle 14 in the housing 12 is an axial bore which contains a lube deflector 16. In conjunction with the present invention, an insert 18 can also be added to the axial bore, with the lube deflector 16 designed to fit around the insert 18.

The use of the lube deflector 16 provides several possible advantages. During shipping, it can help insure that a spacer (not shown, included for pre-installation shipping) retains its appropriate position, until the unit is attached to the spindle (not shown). Additionally, during usage of the hub assembly, the presence of the lube deflector in the axial bore can allow for a decreased volume of lubricant in the bore. This reduction in lubricant can result in a significant cost savings over the life of the hub from the reduction in lubricant required.

Another feature of the invention is that the insert 18 can comprise a magnetic material or include a magnet. This can be beneficial in that the lubricant can be contaminated during use by metal shavings or fragments, and the magnetic insert 18 can substantially prevent such metal fragments from continuing to circulate in the lubricant.

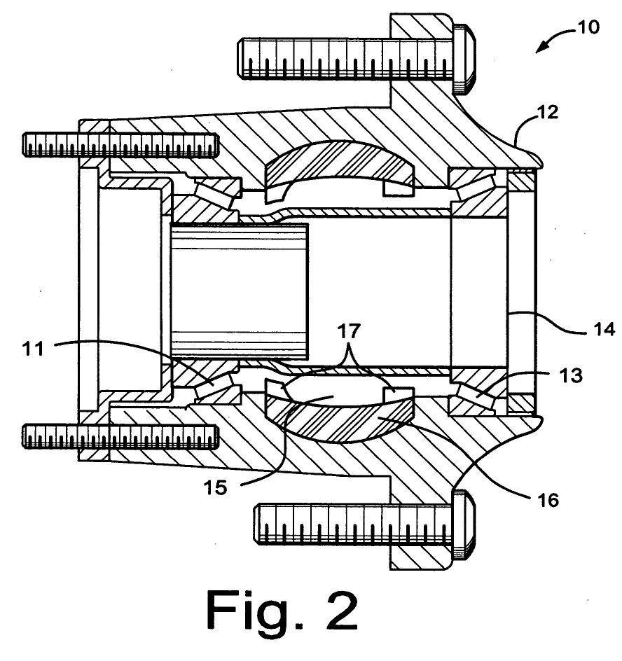

FIG. 2 shows an alternative embodiment of an insert according to the present invention. In this embodiment, the lube deflector 16 is formed in such a manner as to include side sections 17 which define a channel 15. The lube deflector 16 can thus be formed in a manner to direct the flow of lubricant towards the bearings 11, 13 instead of the hub cavity.

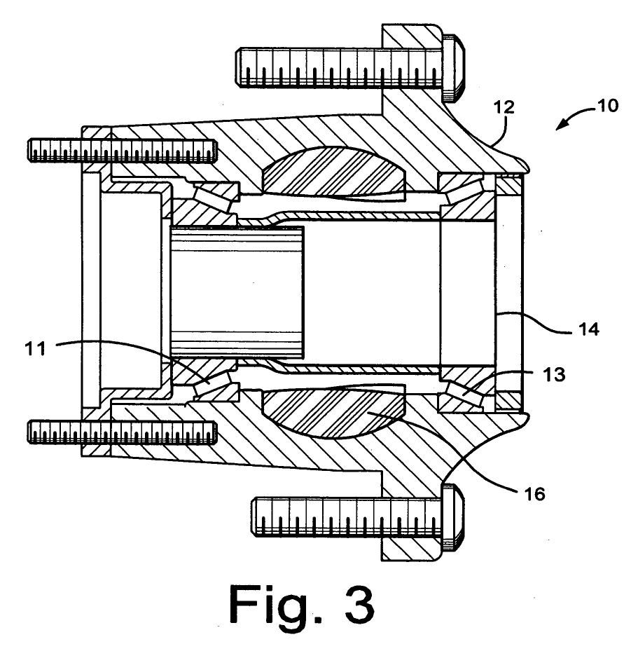

In FIG. 3, a variation of the present invention is shown wherein the lube deflector 16 does not include the side sections 17 as shown in FIG. 2. Instead, the lube director has an outer surface designed to direct the lubricant towards the bearings.

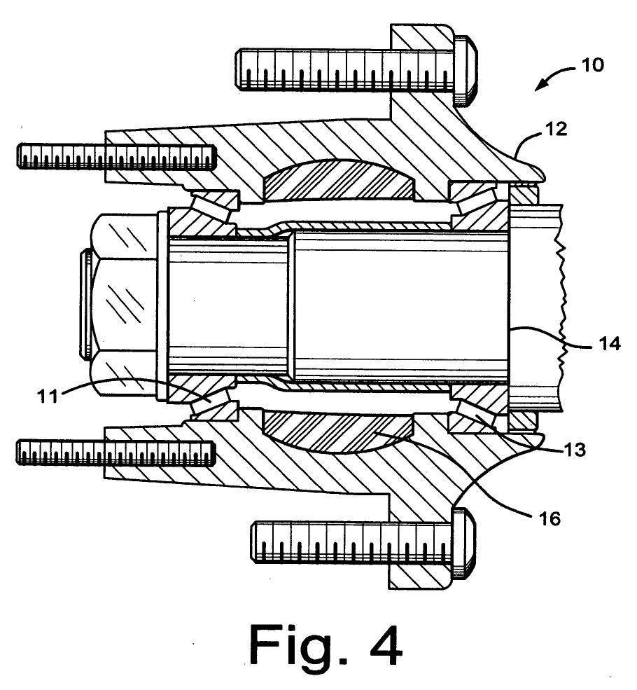

FIG. 4 depicts a further embodiment of the lube deflector of the present invention. In the embodiment of FIG. 4, the lube deflector 16 comprises a foam material delivered into the annular region. The foam material is preferably delivered in the form of a foam spray, which can be directly applied into the annular region. The lube deflector of this embodiment can again decrease the amount of lubricant required in the wheel hub, and has the additional benefit of being an extremely light weight material, decreasing the overall weight of the wheel hub, which again is an economical feature.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A wheel hub lubrication system, comprising:
a body portion of a wheel hub, said body portion having an internal cavity and an annular lubricant depression within said internal cavity; and
a lubricant directing structure secured within said annular lubricant depression to substantially close said annular depression.

2. The wheel hub lubrication system according to claim 1, wherein said lubricant directing structure is magnetic or includes a magnet.

3. The wheel hub lubrication system according to claim 1, wherein said lubricant directing structure is configured to hold a bearing spacer in position during shipment of the hub.

4. The wheel hub lubrication system according to claim 1, wherein the lubricant directing structure comprises a channel.

5. The wheel hub lubrication system according to claim 1, wherein said lubricant directing structure is deformable or can be split or can be in two or more pieces to aid in assembly.

6. The wheel hub lubrication system according to claim 1, wherein said lubricant directing structure is formed from a spray foam fill which substantially fills the annular depression of said inner cavity.

7. The wheel hub lubrication system according to claim 1, wherein said lubricant directing structure comprises rubber.
